(19) United States
(12) Patent Application Publication
(10) Pub. No.: US 2023/0136972 A1
(43) Pub. Date: May 4, 2023

(54) EGOCENTRIC NETWORK ENTITY ROBUSTNESS PREDICTION

(71) Applicant: International Business Machines Corporation, Armonk, NY (US)

(72) Inventors: Ana Paula Appel, Sao Paulo (BR); Renato Luiz de Freitas Cunha, Sao Paulo (BR); Gabriel Louzada Malfatti, Sao Paulo (BR); Emilio Ashton Vital Brazil, Rio de Janeiro (BR); Aliza Rivka Heching, Clifton, NJ (US)

(21) Appl. No.: 17/512,928

(22) Filed: Oct. 28, 2021

(51) Int. Cl. G06Q 40/00; G06Q 10/06

(52) U.S. Cl. CPC G06Q 40/00; G06Q 10/067; H04L 67/12

(57) ABSTRACT

A system may include a memory and a processor in communication therewith. The processor may be configured to perform operations including obtaining an egocentric network with a center node for an entity and receiving data about the entity. The operations may include predicting, with the data, a node array of the egocentric network including a first node to remain, a second node to disappear, and a third node to join the network. The operations may include prognosticating, with the data, a connection array of the egocentric network including a first link connecting the first node to the center node, a second link disappearing from the egocentric network, and a third link connecting the third node to the center node. The operations may include updating the egocentric network to reflect the node and connection arrays, generating an output based on the egocentric network, and displaying the output to a user.

### BACKGROUND

The present disclosure relates to egocentric networks and more specifically to forecasting using egocentric networks.

Financial health of institutions may be assessed for various purposes. For example, a company may conduct an internal diagnosis of its financial situation to identify its own strengths and weaknesses to determine a plan to progress toward business goals. Predicting the financial health of an institution may involve multiple variables, and internal financial audits may not provide extensive data regarding financial health.

### SUMMARY

Embodiments of the present disclosure include a system, method, and computer program product for entity robustness prediction using one or more egocentric networks.

A system in accordance with the present disclosure may include a memory and a processor in communication therewith. The processor may be configured to perform operations including obtaining an egocentric network with a center node for an entity and receiving data about the entity. The operations may include predicting, with the data, a node array of the egocentric network including a first node to remain, a second node to disappear, and a third node to join the network. The operations may include prognosticating, with the data, a connection array of the egocentric network including a first link connecting the first node to the center node, a second link disappearing from the egocentric network, and a third link connecting the third node to the center node. The operations may include updating the egocentric network to reflect the node and connection arrays, generating an output based on the egocentric network, and displaying the output to a user.

In some embodiments, the operations may include compiling information from at least one source and building the egocentric network based on the information.

In some embodiments, the operations may include initiating a loop of the receiving, the predicting, and the prognosticating.

In some embodiments, the output may include at least one of an updated egocentric network, an entity output prediction, and a new node recommendation.

In some embodiments, the operations may include forecasting a fourth node of the node array connected to the center node via the first node. In such an embodiment, the fourth node may be connected to the first node via a fourth link. In this way, the fourth node may be indirectly connected to the center node if it is only connected to the center node by way of the first node.

In some embodiments, the operations may include projecting a future egocentric network using the data.

A computer-implemented method in accordance with the present disclosure may include obtaining an egocentric network for an entity; the egocentric network may have a center node. The method may include receiving data about the entity. The method may include predicting, with the data, a node array of the egocentric network; the node array may include a first node to remain in the egocentric network, a second node to disappear from the egocentric network, and a third node to join the egocentric network. The method may include prognosticating, with the data; the connection array may include a first link connecting the first node to the center node, a second link disappearing from the egocentric network, and a third link connecting the third node to the center node. The method may include updating the egocentric network to reflect the node array and the connection array, generating an output based on the egocentric network, and displaying the output to a user.

In some embodiments, the method may include compiling information from at least one source and building the egocentric network based on the information.

In some embodiments, the method may further include retrieving a portion of the information from an external source.

In some embodiments, the method may include initiating a loop of the receiving, the predicting, and the prognosticating. In some embodiments, the method may further include achieving a threshold and exiting the loop.

In some embodiments, the output may include at least one of an updated egocentric network, an entity output prediction, and a new node recommendation.

In some embodiments, the method may include forecasting a fourth node of the node array connected to the center node via the first node, wherein the fourth node connects to the first node via a fourth link.

In some embodiments, the method may include projecting a future egocentric network using the data.

A computer program product in accordance with the present disclosure may include a computer readable storage medium having program instructions embodied therewith, and the program instructions may be executable by a processor and cause the processor to perform a function. The function may include obtaining an egocentric network for an entity; the egocentric network may have a center node. The function may include receiving data about the entity. The function may include predicting, with the data, a node array of the egocentric network; the node array may include a first node to remain in the egocentric network, a second node to disappear from the egocentric network, and a third node to join the egocentric network. The function may include prognosticating, with the data; the connection array may include a first link connecting the first node to the center node, a second link disappearing from the egocentric network, and a third link connecting the third node to the center node. The function may include updating the egocentric network to reflect the node array and the connection array, generating an output based on the egocentric network, and displaying the output to a user.

In some embodiments, the function may include compiling information from at least one source and building the egocentric network based on the information.

In some embodiments, the function may include initiating a loop of the receiving, the predicting, and the prognosticating.

In some embodiments, the output may include at least one of an updated egocentric network, an entity output prediction, and a new node recommendation.

In some embodiments, the function may include forecasting a fourth node of the node array connected to the center node via the first node, wherein the fourth node connects to the first node via a fourth link.

In some embodiments, the function may include projecting a future egocentric network using the data.

The above summary is not intended to describe each illustrated embodiment or every implement of the disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates a system in accordance with some embodiments of the present disclosure.

FIG. 2A depicts an egocentric network in accordance with some embodiments of the present disclosure.

FIG. 2B illustrates an egocentric network in accordance with some embodiments of the present disclosure.

FIG. 3 depicts an egocentric network progression over time in accordance with some embodiments of the present disclosure.

FIG. 4 illustrates a system generating an entity egocentric network in accordance with some embodiments of the present disclosure.

FIG. 5 depicts an entity robustness prediction mechanism in accordance with some embodiments of the present disclosure.

FIG. 6 illustrates a system implementing a method in accordance with some embodiments of the present disclosure.

FIG. 7 depicts a method in accordance with some embodiments of the present disclosure.

FIG. 8 illustrates a block diagram of an example computing environment in which illustrative embodiments of the present disclosure may be implemented.

FIG. 9 depicts a block diagram of an example natural language processing system configured to analyze a recording to identify a particular subject of a query, in accordance with embodiments of the present disclosure.

FIG. 10 illustrates a cloud computing environment, in accordance with embodiments of the present disclosure.

FIG. 11 depicts abstraction model layers, in accordance with embodiments of the present disclosure.

FIG. 12 illustrates a high-level block diagram of an example computer system that may be used in implementing one or more of the methods, tools, and modules, and any related functions, described herein, in accordance with embodiments of the present disclosure.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to egocentric networks and more specifically to forecasting using egocentric networks.

Financial information related to a company may be identified, monitored, and assessed to determine the financial health of the company in real time. Similarly, the financial information related to the company may be identified, monitored, and assessed to predict the future financial health of the company in real time. Changes in current data may reflect in both the determination of the present financial health of the company as well as update the prediction about the future financial health of the company.

The present disclosure may be used for monitoring entity robustness such as financial information related to companies to predict financial health; the present disclosure may be used for real-time analysis of data such that the present and future robustness (e.g., financial health) of an institution may be identified and predicted, respectively, in real time. The present disclosure may be used for assessing current and predicting future robustness of an entity (e.g., a company, institution, or organization) by considering risk posed by one or more systems involving the entity. Entity information (e.g., financial statements, cash flow, and stock price data) and entity relationship information (e.g., supplier data, competitor data, partner data, and customer trend data) may be analyzed for the evaluation of the robustness (e.g., financial health) of the entity.

Egocentric networks may be used for the evaluation of entity robustness. An egocentric network (which may also be referred to as an ego network or ego net) is a small network with a center node connected to related nodes, and related nodes maybe connection among themselves. An egocentric network may be described as a center node with related nodes of up to n hops of attenuation from the center node, and related nodes can be connected among them.

Related nodes may be directly or indirectly related to the center node. A directly related node is a node connected to a central node with no intervening nodes; such a relational node may be described as being one hop away from the center node. A direct relation between a center node and a related node may be, for example, a company and a customer (one hop) of the company (hop zero). An indirectly related node is a node connected to a central node through at least one other node (e.g., at least one degree of attenuation); such a relational node may be described as being multiple (two or more) hops away from the center node. An indirect relationship between a center node and a related node may be, for example, a company and the supplier (two hops) of an entity in a joint partnership (one hop) with the company (hop zero).

Egocentric networks may be temporally predicted for one or more entities. Egocentric networks may be used to identify changes in relationships or links between the entities and predict the strength of an entity in light of predicted changes. For example, a company (center node) may have three direct suppliers (one hop) each with their own suppliers (two hops); an egocentric network may enable the company to identify perils of problems two hops up the supply chain. Egocentric networks may be used to predict several hops, including predicting the result of one or more predictions on other elements of the network. Predictions may be used to render other predictions, and several iterations may be used to identify the overall risk of a set of circumstances. In some embodiments, such predictions may be used to identify a problem as it is occurring as well as determine a mechanism for halting an unwelcome cascade.

In some embodiments, the present disclosure discusses identifying a central node and its related nodes up to a certain level of attenuation in an egocentric network, predicting which related nodes are likely to remain in the ego network, predicting which related nodes will disappear from the ego network, and predicting which new nodes will be introduced to the ego network.

The egocentric network of an entity may be used to predict the robustness of the entity. In some embodiments, the entity may be a company, organization, government, corporation, partnership, or other institution. In some embodiments, the robustness may represent the financial health, talent recruitment process strength, or other measurable attribute of the entity. In some embodiments, the present disclosure may be used to predict the financial health of one entity by comparing the egocentric network of the one entity to the egocentric network of another company.

In some embodiments, the one entity may be relatively unknown (e.g., a startup company) and the other company may have a long record of financial stability (e.g., a blue-chip company). In some embodiments, multiple relatively unknown entities (e.g., competing startup companies) may be compared, for example, to identify variations in company operations. In some embodiments, multiple relatively known companies may be compared, for example, to identify mechanisms for strengthening a company position and/or supply chain.

Predicting the robustness (e.g., financial health) of an entity can be extremely difficult. For assessing the financial situation of a company, for example, many variables may be considered such as revenue, income, gross profit, net profit, expenses, expense type, asset acquisition, asset depreciation, and the like. Assessing financial stability of an entity may include assessing the cash flow and similar fiscal data of the entity; a thorough assessment may include non-pecuniary data.

Relationships with other entities may be considered because an entity often relies on other entities. For example, if the sole supplier of a company goes out of business, the company is impacted because its supply chain is disrupted, and the company may need to source the supplies from elsewhere, retool to internally compensate, change its offerings, or the like. Simultaneously, if a crucial customer exits the business, the company may need to compensate for the loss of sales. Aspects of the present disclosure may identify entity interrelationships and dependencies.

The present disclosure considers changes to an entity over time, including, for example, changes in entity cash flow, sales changes (e.g., a seasonal increase in sale volume), relationships with other entities (e.g., suppliers and customers), and the like. Some embodiments of the present disclosure may be used to assess the robustness of an entity in real time such that a change to an entity may be immediately reflected in the robustness assessment results.

In some embodiments, the present disclosure may be used to predict future robustness given anticipated changes. A company may, for example, predict its financial stability through the end of a fiscal quarter, calendar year, or other timeframe based on its business relationships, financial data, and other information. Some embodiments of the present disclosure may use a pre-existing egocentric network of the entity of interest, reference additional internal entity data (e.g., financial sheets and invoices to and from other entities), interpolate additional information, extrapolate additional information, and update the egocentric network according to anticipated changes. Some embodiments may use internal entity data as well as external data including public information (e.g., public-facing governmental filings, investor reports, news articles, and corporate announcements) to build an egocentric network for the entity, update the egocentric network over time, and predict future changes to the egocentric network.

In some embodiments, an egocentric network may be used to anticipate potential disruptions impacting an entity. The present disclosure may be used to interpolate a pattern of a related entity being less responsive during certain seasons and extrapolate when similar circumstances are likely to occur. For example, a supplier may be overwhelmed with orders during a busy season, or certain seasonal weather patterns may render communications between two companies inoperable. In some embodiments of the present disclosure, an egocentric network may enable an entity to compensate for an anticipated disruption and thus be prepared for it.

Some aspects of the present disclosure use egocentric networks for assessment and prediction of robustness. Egocentric networks can incorporate substantial insight while remaining small (e.g., requiring minimal storage space) and light (e.g., requiring minimal computational power to process and/or use for predictions). In some embodiments, the use of egocentric networks may improve security, privacy, and computation speed because egocentric networks store minimal data. For example, a full graph may be distilled into key points for use in an egocentric network, and any other data may be retained on the full graph and not transferred to the egocentric network.

In some embodiments, the present disclosure uses egocentric networks to predict the current and future robustness of an entity. For example, company information in a full graph (such as financial statements, supplier relationships, customer relationships, and historical data) may be distilled into an egocentric network using a machine learning (ML) model, and the ML model may be used to identity current and predict future financial health of the company based on the financial information and information known about related entities.

The present disclosure may, in some embodiments, help a user identify the likelihood that an entity will grow or diminish. In some embodiments, the present disclosure may also enable a user to identify factors positively or negatively impacting an entity. In some embodiments, the present disclosure may enable a user to assess and improve the situation for an entity by, for example, rendering an entity robustness score (e.g., 7.3 out of 10) and recommending actions to improve the score (e.g., incorporate an additional supplier into its supply chain and partner with another entity for a joint venture). In some embodiments, the present disclosure may use data from sources both internal (e.g., entity-owned data) and external (e.g., websites and press releases) to identify opportunities. For example, an egocentric network may highlight heavy reliance on one supplier, and an additional supplier may be identified and recommended.

In accordance with the present disclosure, several aspects of an entity may be considered in its a robustness prediction. For example, a robustness prediction may include a company cash flow, its supply chain, expected sales, likelihood of meeting projected sales targets based on strength of the supply chain and anticipated market demand, and the like. In accordance with the present disclosure, an egocentric network entity robustness prediction may account for information about other entities related to the entity (e.g., direct and indirect suppliers, customers, competitors, partners, and the overall market) as well as the entity itself. Some embodiments of the present disclosure may incorporate data from various sources into an entity egocentric network to assess current and future robustness of the entity.

A robustness assessment or prediction in accordance with the present disclosure may be used by one or more entities. In some embodiments, such a robustness quantification may be used as part of an evaluation to determine a course of action. For example, an investor may use a robustness assessment and prediction to identify whether or not the investor will invest in a particular company, risks involved with investing in the company, strengths of the company, the feasibility of circumventing potential difficulties, conditions the investor may attach to the investment, and the like.

Similarly, a financing agency may consider a robustness analysis and prediction while reviewing an application by the entity for a line of credit. For example, a bank may identify that a company applying for a loan has a negative balance sheet for the previous two quarters, a ten-year track record, a current robustness assessment of 5.3/10, and a predicted steady robustness growth which will reach 8.2/10 by the end of the year; the bank may use the robustness analysis to determine that the company would have difficulty repaying a six-month loan under standard agreement terms but would likely be able to repay a one-year loan under similar terms.

In some embodiments, a financing agency may use an assessment and predictions in accordance with the present disclosure to target offers for a specific entity. For example, an equity investment group may identify a startup company has a current robustness assessment of 3.1/10 and is predicted to go into bankruptcy within the next quarter but, with some modifications to the company system and a monetary infusion, the company is likely to be profitable within three quarters; the investment group may contact the company, identify hurdles and solutions, and offer to partner with the company in exchange for an equity stake in the company.

In addition to providing a quantifiable assessment of entity robustness, the present disclosure may enable a more thorough recognition of strengths and weaknesses of an entity. In accordance with the present disclosure, data from various available sources may be incorporated into a robustness assessment and/or prediction. In some embodiments, internal data may establish an initial egocentric network for an entity and various external data sources may be used to update the egocentric network. For example, in accordance with the present disclosure, a company may build an initial egocentric network for itself based on its financial statements and partnership agreements, employ a ML system to train a data crawler, use the crawler to identify and pull relevant information from public sources (e.g., news articles) about suppliers and partners, and update the egocentric network to reflect the data retrieved by the crawler. Incorporating external data in accordance with the present disclosure may provide a more complete profile of an entity.

The present disclosure may, in some embodiments, be used to capture historical entity behavior and that of other entities in connection with the entity. Historical data, including behavior and the impact of such behavior, may be used to identify current and predict future robustness. Data concerning connections and the nature of the connections may be used in the assessment and prediction of robustness of the entity.

The activity of connected entities may impact an entity in a variety of ways. For example, a company with one supplier for a crucial component of a product offering would likely be more negatively impacted by the supplier going into bankruptcy than a similar company using three suppliers for the same component. Similarly, if a company incorporates a new supplier into its supply chain, the company will likely have more ability to adapt when another supplier faces its own supply chain issues. The flexibility of an entity may be reflected in a robustness assessment and/or prediction in accordance with the present disclosure.

Predicting future connections such as suppliers, customers, stakeholders, and other related entities may include, in some embodiments, identifying potential new connections that the entity will connect with, current connections that are likely to remain connected with the entity, and current connections that are likely to not be connected to the entity at the time of the prediction. For example, a corporation may have three current suppliers; a system in accordance with the present disclosure may calculate that one is likely to remain, one is likely to go out of business next quarter, and one is likely to pivot to a different business by the end of the year. In the same example, the system in accordance with the present disclosure may identify three additional suppliers likely to contract with the corporation over the next six months.

In accordance with the present disclosure, a system may identify connections of an entity, the nature of the connections, the strength of the connections, the reliance on the connections, and the like. For example, a system in accordance with the present disclosure may identify a company has ten connections consisting of three suppliers and seven customers, one of the suppliers provides 70% of the supplies, and one of the customers accounts for 57% of all sales; the robustness assessment for the company may include a robustness score and a recommendation to decrease reliance on a particular vendor and/or patron.

The present disclosure may, in some embodiments, be used to predict robustness of an entity by analyzing information about the entity and related entities. One or more egocentric networks may be used for assessment and prediction of robustness for the entity and/or related entities. Egocentric networks and the number of degrees of attenuation (also referred to as hops) thereof may be modified based on various goals. For example, one egocentric network may include a center node (the entity) and only directly related entities (one hop away) whereas another egocentric network may include four hops for a particularly detailed analysis.

In some embodiments of the present disclosure, a system may monitor financial information related to an entity to predict financial health in real time. The system may consider risks, strengths, and other considerations posed by the systems the entity is part of (e.g., supply chain networks upon which the company relies) in addition to information about the entity. The system may analyze information relevant to the relationships of the entity including, for example, data about the robustness of related companies and the amount of business the entity does with each company. The system may utilize one or more egocentric networks for assessment and prediction of robustness for the entity and/or companies in relationship therewith.

In accordance with the present disclosure, some embodiments may assess and/or predict an egocentric network temporally for an entity. In some embodiments, an egocentric network may be generated temporally for both an entity (the center node) and each entity to which it is related. Temporal assessments and predictions in accordance with the present disclosure may accelerate the discovery of any changes to any of the links in an egocentric network, thereby providing a thorough assessment and prediction of the robustness of an entity. For example, accounting for changes in real time may quickly identify a potential issue in a supply chain and provide an opportunity for an entity to address it before it becomes an issue.

Some embodiments of the present disclosure may use one or more computational and/or analytical tools for identifying, analyzing, incorporating, and otherwise using relevant data. Such tools may include, for example, ML, deep learning, graph learning, graph embedding, traditional and/or untraditional node prediction methods, graph neural network (GNN), graph metric analysis, traditional and/or untraditional link prediction mechanisms such as a common neighbor (CN) algorithm or the Adamic/Adar index, natural language processing (NLP), text mining, graph mining, regression modeling, regression analysis, support vector machine (SVM) learning models, support vector regression (SVR) learning models, similar tools, or some combination thereof. For example, in some embodiments, ML and graph learning may be used to train an initial model, deep learning and GNN techniques may be used to tune the model, SVM learning techniques may be used for associated learning to analyze data for classification, regression, and outlier detection, and SVR may be used for regression inquiries.

In accordance with the present disclosure, one or more tools may be used independently or in concert with other tools. Each operation may use the same or different tools such that a tool may be used exactly once in some embodiments and multiple times in various operations in other embodiments. For example, in one embodiment, ML may be used in node prediction, link prediction, label prediction, link weight prediction, and the final robustness prediction whereas NLP may be used only during the label prediction operation. In another example in accordance with the present disclosure, ML and NLP may be used in the node prediction and link prediction operations, deep learning and text mining may be used in the link labeling and link weighting operations, and graph mining and graph embedding may be used in the final robustness prediction.

In accordance with the present disclosure, an egocentric network may be obtained, assessed, updated, and analyzed to determine the robustness of an entity.

A system in accordance with the present disclosure may include a memory and a processor in communication with the memory, and the processor may be configured to perform operations. The operations may include obtaining an egocentric network for an entity; the egocentric network may have a center node. The operations may include receiving data about the entity. The operations may include predicting, with the data, a node array of the egocentric network; the node array may include a first node to remain in the egocentric network, a second node to disappear from the egocentric network, and a third node to join the egocentric network. The operations may include prognosticating, with the data, a connection array of the egocentric network; the connection array may include a first link connecting the first node to the center node, a second link disappearing from the egocentric network, and a third link connecting the third node to the center node. The operations may include updating the egocentric network to reflect the node array and the connection array, generating an output based on the egocentric network, and displaying the output to a user.

In some embodiments, the operations may include compiling information from at least one source and building the egocentric network based on the information.

In some embodiments, the operations may include initiating a loop of the receiving, the predicting, and the prognosticating.

In some embodiments, the output may include an updated egocentric network, an entity output prediction, a new node recommendation, or some combination thereof.

In some embodiments, the operations may include forecasting a fourth node of the node array connected to the center node via the first node. In such an embodiment, the fourth node may be connected to the first node via a fourth link. In this way, the fourth node may be indirectly connected to the center node if it is only connected to the center node by way of the first node.

In some embodiments, the operations may include projecting a future egocentric network using the data.

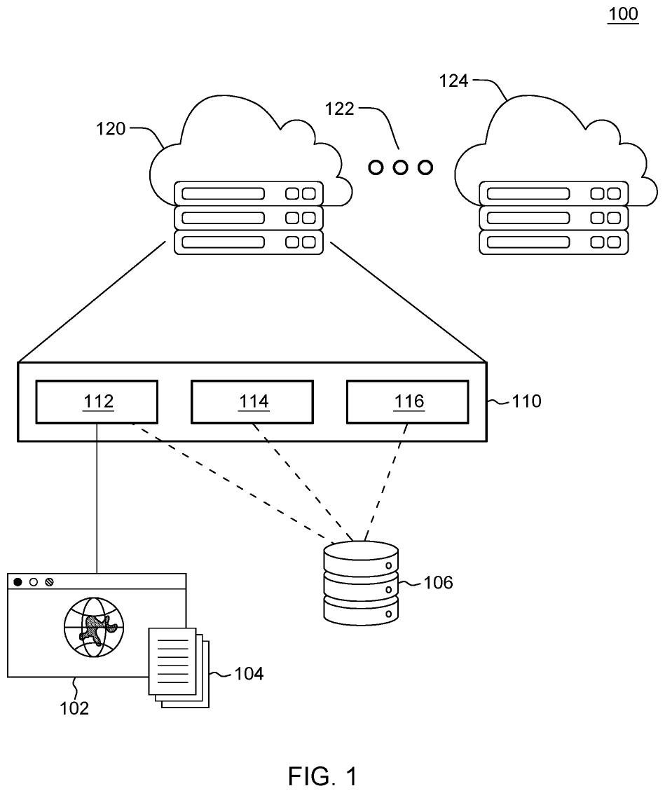

FIG. 1 illustrates a system 100 in accordance with some embodiments of the present disclosure. The system 100 includes a computing infrastructure 120, a robustness predictor 110, and multiple data sources.

The computing infrastructure 120 may be a physical machine, virtual machine (VM), a similar machine, or some combination thereof. The computing infrastructure 120 may be a group of computing resources for hosting the robustness predictor 110 and executing data gathering and prediction operations. The computing infrastructure 120 may be a part of a larger structure such as, for example, a site mainframe. The computing infrastructure 120 may be connected to a mainframe system 124 via a network 122. The network 122 may provide, for example, an intranet, internet, wired, wireless, or other connection. The computing infrastructure 120 may house the robustness predictor 110, and the robustness predictor 110 may include a crawler 112, an egocentric network predictor 114, and a robustness results predictor 116.

The crawler 112 may be a software component that navigates one or more sources to gather data. For example, the crawler 112 may navigate the internet 102 gathering data 104 submitted to governmental agencies, investor relations reports, information published on corporate websites, articles published by journalistic entities, press releases, and the like. Governmental agencies may include, for example, the United States Securities and Exchanges Commission (SEC), a court system, a governing body (e.g., a legislature or executive power), or the like. Data submitted to governmental agencies may be in the form of regulatory reports such as, for example, form 10-K, form 10-Q, schedule 13D, form 3, form 4, form 5, form 144, and the like. The crawler 112 may pull data from the internet 102 and store it in a database 106.

The robustness predictor 110 may include an egocentric network predictor 114. The egocentric network predictor 114 may be a software component that uses the information gathered by the crawler 112 to predict time-based egocentric networks for one or more entities. The egocentric network predictor 114 may generate and/or update one or more egocentric networks. The egocentric network predictor 114 may use information, including information in the database 106 which may include information pulled by the crawler 112, to generate and/or update one or more egocentric networks. In some circumstances, information may only be relevant to one of the stored egocentric networks, resulting in only that egocentric network being updated; in other instances, one new data point may impact multiple stored egocentric networks, resulting in an update for multiple egocentric networks. The egocentric network predictor 114 may store any generated egocentric networks in the database 106.

The robustness predictor 110 may include a robustness results predictor 116. The robustness results predictor 116 may use the data obtained by the crawler 112 and generated by the egocentric network predictor 114 to assess a current and/or predict a future robustness score for an entity. In some embodiments, the robustness results predictor 116 may be an entity financial health predictor such that the robustness results predictor 116 may assess the financial health or strength of an entity (e.g., the likelihood of a company going bankrupt). Results generated by the robustness results predictor 116 may be stored in the database 106 and/or communicated to a user.

A user of the system 100 may be a person performing a robustness analysis of an entity. For example, a user may examine the financial health and stability of a corporate entity (e.g., a company). The user may use a user device to perform the robustness analysis; a user device may be, for example, a computing device the user may directly interact with such as a laptop, desktop, mobile device, or similar. The entity analyzed may be of interest to the user.

In the present disclosure, nodes in an egocentric network may be used to represent entities. The center node in an egocentric network may represent the entity of interest; for example, the center node may represent a company being assessed for financial health. The directly related nodes may represent entities with which the entity of interest has an immediate connection such as, for example, a supplier, a customer, a competitor, and/or a partner. The indirectly related nodes may represent entities with which the entity of interest has a connection that is not immediate such as, for example, a partner of a supplier that supplies the entity of interest.

The present disclosure considers that nodes may have independent relationships with each other. Some embodiments may include a directly related node has a relationship with another node in the network such that it is also an indirectly related node. For example, an entity may have two suppliers that partner with each other such that the suppliers are each directly related entities as well as connected to each other.

For clarity, the present disclosure uses the terms directly and indirectly to identify the number of hops a related node is from the center node; in other words, the center node is the point of reference. The term directly indicates a connection between a center node and an immediately connected node; the term indirectly indicates a connection between a center node and a related node connected to the center node through another node. Similarly, the term primary link is used to describe a connection between a center node and a directly related node and the term secondary link is used to describe a connection between an indirectly related node and the directly related node to which it connects. Links may also be referred to as edges or connections.

In some embodiments, nodes and/or links may store data relevant to the egocentric network, robustness assessment, and/or robustness prediction. Stored data may include, for example, entity (e.g., sales) and relationship (e.g., resource expenditure) information.

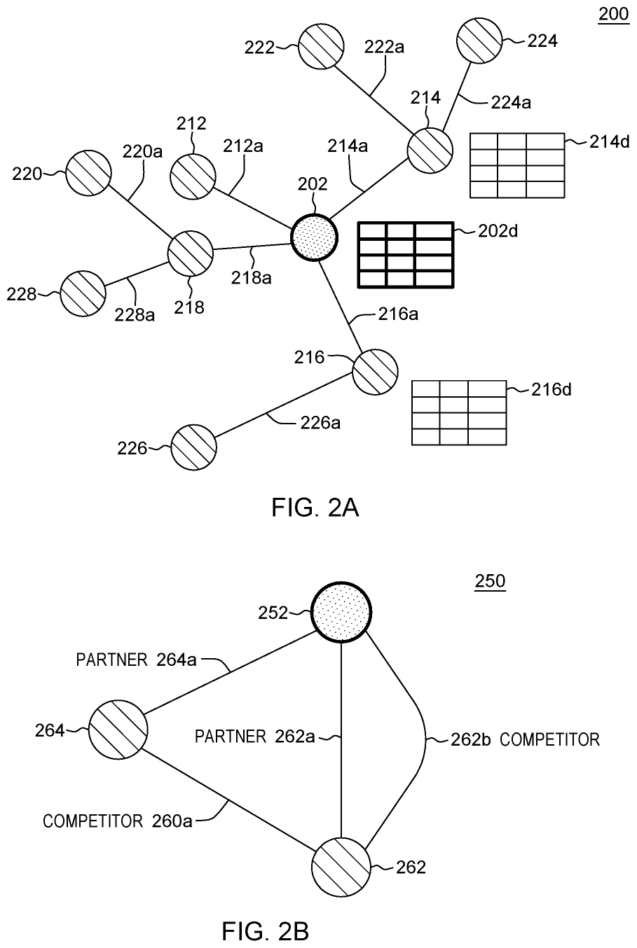

FIG. 2A depicts an egocentric network 200 in accordance with some embodiments of the present disclosure. The egocentric network 200 has a center node 202 connected to four directly related nodes 212, 214, 216, and 218. Each directly related node 212, 214, 216, and 218 is connected to the center node 202 via a primary link 212a, 214a, 216a, and 218a.

The egocentric network 200 includes two hops. One of the directly related nodes 212 is connected only to the center node 202 and not connected to any other nodes. Three of the directly related nodes 214, 216, and 218 are connected to other nodes. One of the directly related nodes 216 is connected to one indirectly related node 226 via a secondary link 226a. Two of the directly related nodes 214 and 218 are each connected to two indirectly related nodes 222, 224, 228, and 220 via secondary links 222a, 224a, 228a, and 220a.

Some of the nodes in the egocentric network 200 are depicted with data charts 202d, 214d, and 216d. The data charts 202d, 214d, and 216d indicate the nodes contain information. The nodes may contain entity information, for example, financial information extracted from financial statements, investor reports, and governmental filings; in some embodiments, the nodes may contain previously calculated robustness scores for the relevant entity. Some, all, or no nodes and/or links in an egocentric network may contain data depending on whether the information is deemed necessary, advantageous, or superfluous in accordance with user goals.

In some embodiments, nodes and/or links may contain relationship information such as the type of relationship between the connected entities, the length of time the entities have been connected, the amount of resources invested in the relationship (e.g., purchasing an average of $2 million in product from a supplier quarterly, or spending an hour per day working with each other), the regularity of the relationship (e.g., one quarterly purchase a vendor, three weekly purchases from another vendor, and five irregular purchases from yet another vendor), and the like.

FIG. 2B illustrates an egocentric network 250 in accordance with some embodiments of the present disclosure. The egocentric network 250 includes one hop of attenuation. The center node 252 has two directly related nodes 262 and 264.

One directly related node 264 is a partner of the center node 252, and the relationship data is included in the link 264a connecting the nodes. One directly related node 262 is both a partner and a competitor of the center node 252, and the data about the relationship is contained in the links 262a and 262b connecting the two nodes. In some embodiments, multiple relationship types may be contained in the same link; for example, a link may identify a related node as a partner, supplier, customer, and/or competitor relationship with another node.

External data may be unknown or difficult to properly incorporate into a robustness assessment. An egocentric network 250 may incorporate such external data. For example, the directly related nodes 262 and 264 are related to each other as indicated by the link 260a connecting the nodes. The link 260a between the directly related nodes 262 and 264 includes the relationship data of the directly related nodes 262 and 264, specifically, that the directly related nodes 262 and 264 are competitors.

Egocentric networks may change as an entity and its relationships change. Egocentric networks may be newly generated to reflect changes, and/or egocentric networks may be updated to reflect changes. In some embodiments, predictors may be coupled together to update and/or refine an egocentric network and/or a prediction thereof. Coupling predictors may enhance the accuracy of the egocentric network and related information.

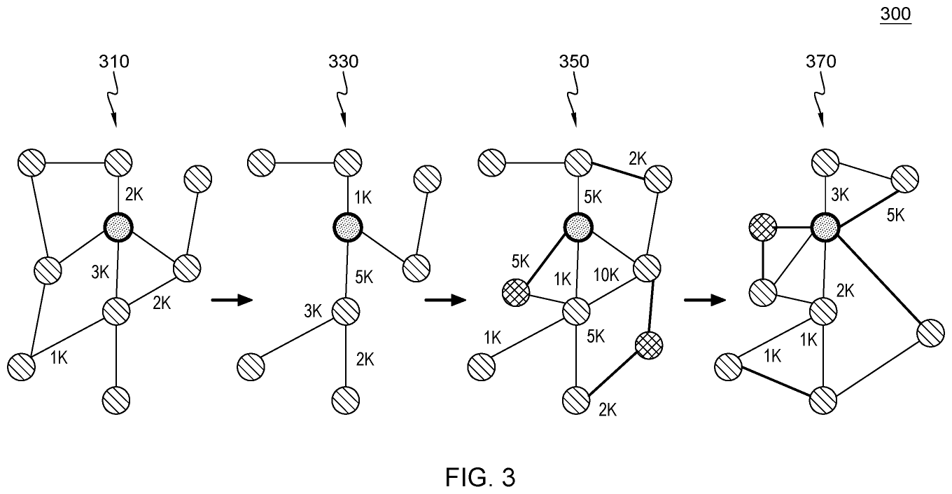

FIG. 3 depicts an egocentric network progression 300 over time in accordance with some embodiments of the present disclosure. The egocentric network progression 300 includes two hops of attenuation from the center node.

The first egocentric network 310 may be updated and/or refined into a second egocentric network 330. The second egocentric network 330 may be updated and/or refined into a third egocentric network 350, and the third egocentric network 350 may be updated and/or refined into a fourth egocentric network 370. The progression may continue such that the fourth egocentric network 370 evolves into a fifth, the fifth into a sixth, and so on.

The egocentric networks shown in the egocentric network progression 300 include center nodes, directly related nodes and indirectly related nodes that may have relationships with each other, steady nodes (e.g., nodes that remain between the update from the first egocentric network 310 to the second egocentric network 330) and newly generated nodes (e.g., nodes that are added into the second egocentric network 330 when updating to the third egocentric network 350), primary links and secondary links, steady links and newly generated links, relationship data (e.g., type of relationship and resources exchanged in the relationship), and the like. The egocentric network progression 300 details an example of how egocentric networks may change over time including, for example, new entities, new relationships between entities, disappearance of previous relationships, change in relationship type(s), change of relationship quantifier(s), and the like.

The nodes in the egocentric network progression 300 are coded with patterns for convenience: the center nodes are dotted, the existing connection nodes have a lined pattern, and the new connection nodes have a grid pattern. Similarly, the links in the egocentric network progression 300 are coded with patterns for convenience: the existing links are solid and the newly generated links are dashed. Other mechanisms (e.g., color coding) may be used, or no such indicators may be used at all, which may be decided by user preference.

As shown in FIG. 2B, an entity (represented by nodes) may have multiple relationship types with another entity (e.g., partners, customers, and competitors). Relationship types may evolve over time. For example, a directly related node entity may start as a supplier to a center node entity; later, the directly related node entity may continue to supply the center node entity with its product and also purchase products from the center node entity; the relationship may change further such that the entities no longer supply each other but rather are in partnerships with each other in one venture and competitors with each other in another venture.

The updates and/or refinements to the egocentric networks 310, 330, 350, and 370 may occur in real time (e.g., as relevant entities change), provide historical data (e.g., explain how an entity changed over time), or provide predictive insights (e.g., anticipate likely changes).

Predicting a reliable egocentric network can be challenging. The challenge of reliably predicting an ego network to render reliable predictions can be met with data incorporation. Data may be gathered (e.g., mined with a crawler) from internal entity documents (e.g., from a full graph, invoices between companies, and/or meeting notes), documents from the related entity (e.g., an entity website, corporate statements, public reports to governmental agencies, and/or investor reports), and external sources (e.g., news articles and/or third-party websites).

In some embodiments, data gathering and/or incorporation may occur before initially constructing an egocentric network. For example, internal and external data may be mined, aggregated, and used to construct a fully developed egocentric network which may be updated as data comes in and/or extrapolated from to predict how it will change over time. In some embodiments, data gathering and/or incorporation may occur in stages of building, updating, and/or refining an egocentric network. For example, internal entity data may be used to construct an initial egocentric network as external data is mined and aggregated; the external data may be used to refine the initial egocentric network into a developed egocentric network.

Each egocentric network may reflect the robustness of one entity according to the incorporated data at a given time. Each node in the ego network may have an associated feature vector with an Altman Z-score, industry, revenue, and the like. Information may also be included on the edges or links; such information may include, for example, type of relationship, transaction amount, and the like.

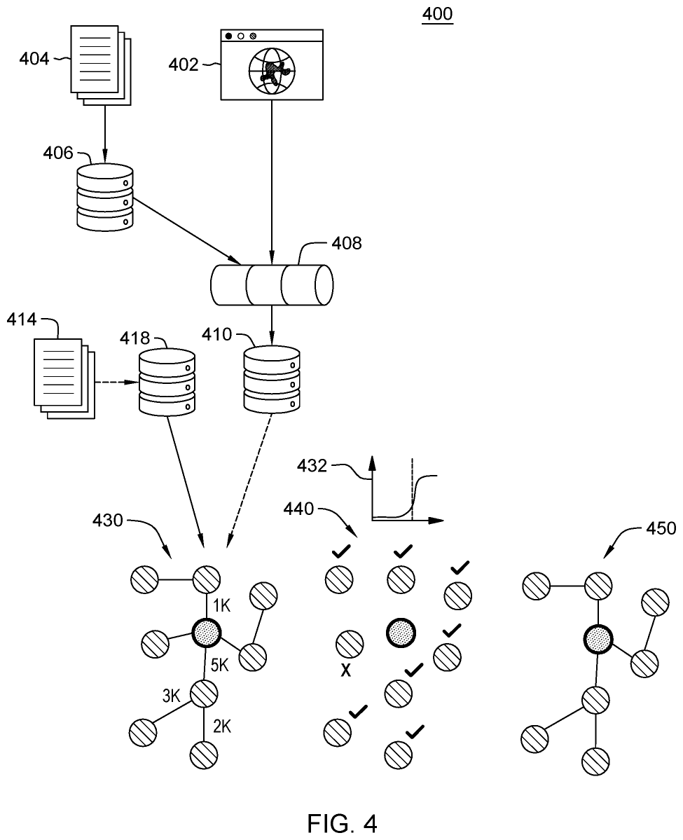

FIG. 4 illustrates a system 400 generating an entity egocentric network in accordance with some embodiments of the present disclosure. The system 400 uses various data sources, databases, and equipment to generate an egocentric network 430.

The system 400 includes files 404 submitted to a first database 406 in communication with a message queue apparatus 408. The first database 406 may submit relevant data to the message queue apparatus 408. Dynamic data sources 402 may be submitted directly to the message queue apparatus 408. The message queue apparatus 408 may submit collected information to a second database 410. One or more additional sources 414 may be submitted to a third database 418. Data in the second database 410 and third database 418 may be aggregated to construct the egocentric network 430.

Additional data 432 may be provided to deconstruct the egocentric network 430 to form an aggregation of relevant nodes 440 and generate an updated egocentric network 450 therefrom. In some embodiments, tools such as a neural network (NN) may be used to provide the additional data 432 which may include, for example, a distribution of the likelihood of a node remaining in the egocentric network 430 and any likely changes to link data. Likely changes may be reflected in the updated egocentric network 450.

Egocentric networks may be updated and/or refined. In some embodiments of the present disclosure, an egocentric network may be built, deconstructed, reconstructed, refined, updated for node and/or link changes, elaborated upon with data (e.g., entity information, relationship type, value of resources invested in the relationship, et cetera), used to assess current entity robustness, used to predict future entity robustness, tune the egocentric network prediction mechanism, or some combination thereof.

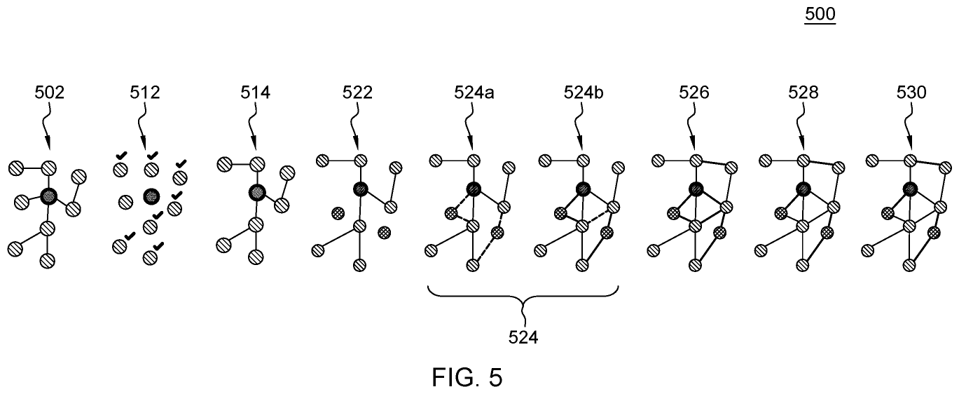

FIG. 5 depicts an entity robustness prediction method 500 in accordance with some embodiments of the present disclosure. An initial egocentric network evolves into a final egocentric network which may be used to assess the robustness of the entity.

During an initial phase 502, the initial egocentric network may be constructed using, for example, internal documents, public data, governmental report information, news articles, press releases, or some combination thereof. In some embodiments, the initial egocentric network may be constructed from internal entity information; other data may be incorporated later in the entity robustness prediction mechanism 500. Data sources (e.g., news websites) may be monitored such that additional information may be added to the databases aiding in the construction, update, refinement, and prediction process; additional information may be integrated into one or more relevant egocentric networks in real time or in a further iteration (e.g., a prediction for the following quarter, or at a pre-selected time to run an analysis).

During a second phase 512, the initial egocentric network may be deconstructed into a node array. A binary classification may then be performed to identify which of the nodes in the node array will remain and which will disappear. The binary classification used may be any known or hereinafter used in the art such as, for example, pre-defined algorithms, deep learning mechanisms, NNs, deep neural networks (DNNs), GNNs, other models, and the like.

During a third phase 514, the remaining nodes in the node array may be reconnected into a reconstructed egocentric network. The links, link properties (e.g., relationship type), node properties (e.g., placement in the network), and other data from the initial egocentric network may be carried over into the reconstructed egocentric network.

During a fourth phase 522, new (additional) nodes may be predicted for addition to the egocentric network.

During a fifth phase 524, links may be predicted to connect the new nodes to the egocentric network. The fifth phase 524 may occur in multiple parts such as a first link prediction operation 524a and a second link prediction operation 524b. Other phases may also occur in multiple parts, and the fifth phase 524 may not have multiple parts in some embodiments.

In some embodiments, the first link prediction operation 524a may establish primary connections whereas the second link prediction operation 524b may establish secondary connections. In some embodiments, the first link prediction operation 524a may connect any new nodes to the egocentric network and the second link prediction operation 524b may add one or more connections between pre-existing nodes in the egocentric network. In some embodiments, the links established during the first link prediction operation 524a may assist in the prediction of the links for the second link prediction operation 524b.

Other phases employing multiple parts may also employ similar mechanisms to that described for the fifth phase 524 regarding the interrelation between the steps. For example, the fourth phase 522 may be done in multiple parts such that an initial new batch of nodes enables an additional new batch of nodes thereafter. In another example, link labeling of primary connections may occur as a first operation of a sixth phase 526 and link labeling of secondary connections may occur as a second operation of the sixth phase 526.

The sixth phase 526 includes the labeling of the connecting links. The sixth phase 526 may include adding new labels to new links, updating labels on previous links, refining labels, and the like. Labels may include, for example, the type(s) of relationship between two entities (e.g., supplier and partner) and other relationship information.

The seventh phase 528 includes predicting link value. Link value may be quantified based on user identified weight factors which may or may not be weighted. Such factors may include, for example, length of the relationship, total money spent in the relationship, recent expenditures spent in the relationship, individual transaction values, benefits derived from the relationship (e.g., contact with certain people in the industry), and the like.

In the eighth phase 530 of the method 500, the resulting egocentric network may be used to predict an entity robustness score (e.g., score of the financial health of a company).

In some embodiments, one or more of the phases may be repeated. In some embodiments, a loop may be implemented until an accuracy threshold is reached; for example, the node, link, link labeling, and link weight prediction operations may be looped such that link weight prediction may return the method 500 to node prediction until 80% accuracy is achieved.

Each of the phases may use ML techniques, algorithms, and similar known art. For example, one or more of the above phases may use ML, deep learning, natural language processing (NLP), inference algorithms, GNN, graph embedding, traditional methods of node prediction, recognized mechanisms for link prediction (e.g., the Adamic/Adar index and common neighbor predictors), regression analyses, graph learning, text mining, graph mining, similar techniques, or some combination thereof. Such techniques may be useful for obtaining or constructing an egocentric network, evaluating a node array, predicting new nodes, links, labels, weights, results, and/or updating the information for nodes, links, labels, weights, and/or results.

For example, in one egocentric network, graph embedding and ML may be used to predict new nodes, the Adamic/Adar index may be used to predict new links, NLP may be used to infer the relationships between nodes, a regression analysis may be used to identify weights of the links (e.g., quantified relationship value such as resources expended in the relationship), and a combination of graph embedding and ML may be used to distill and render final results reflecting entity robustness.

Some embodiments may use the same or differing techniques in each loop of the method 500. Additionally, in some embodiments, as additional data becomes available, the additional data may be incorporated into the process in real time, at the next loop, or at an identified data addition point. In some embodiments, the method 500 may repeat in its entirety such that the entity robustness score may be used to predict additional information, leading to a ripple effect of additional predicted data. As events occur, the event data may be used to update any current assessment and future predictions.

In some embodiments, an egocentric network prediction progression may branch into multiple possibilities. For example, an egocentric network may be developed and used to predict a future egocentric network; the data may indicate that a critical decision is likely to occur and project the likely scenarios for each decision result. In some embodiments, a user may utilize an egocentric network prediction tree to identify a preferable decision based on the likely result of the robustness of the entity in each scenario.

A computer program product in accordance with the present disclosure may include a computer readable storage medium having program instructions embodied therewith, and the program instructions may be executable by a processor and cause the processor to perform a function. The function may include obtaining an egocentric network for an entity; the egocentric network may have a center node. The function may include receiving data about the entity. The function may include predicting, with the data, a node array of the egocentric network; the node array may include a first node to remain in the egocentric network, a second node to disappear from the egocentric network, and a third node to join the egocentric network. The function may include prognosticating, with the data; the connection array may include a first link connecting the first node to the center node, a second link disappearing from the egocentric network, and a third link connecting the third node to the center node. The function may include updating the egocentric network to reflect the node array and the connection array, generating an output based on the egocentric network, and displaying the output to a user.

In some embodiments, the function may include compiling information from at least one source and building the egocentric network based on the information.

In some embodiments, the function may include initiating a loop of the receiving, the predicting, and the prognosticating.

In some embodiments, the output may include at least one of an updated egocentric network, an entity output prediction, and a new node recommendation.

In some embodiments, the function may include forecasting a fourth node of the node array connected to the center node via the first node, wherein the fourth node connects to the first node via a fourth link.

In some embodiments, the function may include projecting a future egocentric network using the data.

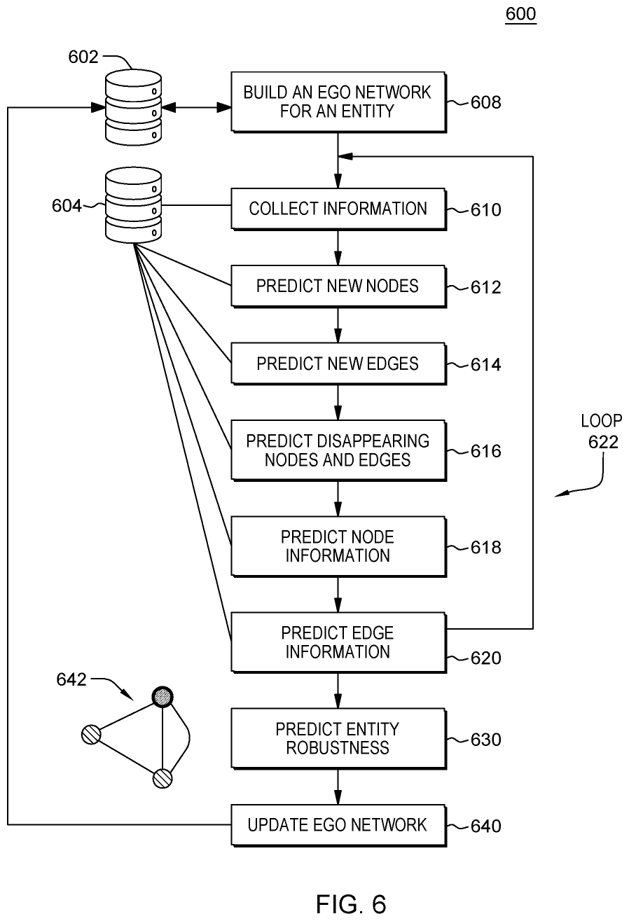

FIG. 6 illustrates a system 600 implementing a method in accordance with some embodiments of the present disclosure. The system 600 includes multiple databases 602 and 604 performing in concert with a processor (not shown) to accomplish various functions.

The functions include building 608 an egocentric network for an entity. In some embodiments, an egocentric network may have an existing egocentric network stored in one of the databases 602 or 604 which may be used by the system 600.

The functions include collecting 610 information. The information may be collected from various data sources. The information may include, for example, stock market data (e.g., company market capitalization and volume), financial audit data, entity information, related entity information, industry data, technological data, sector expectations, other data relevant to the entity of interest, and similar information which may be used in the composition of node and link data as well as egocentric network data and metadata. The information gathered during the collecting 610 operation may be used in one or more of the other functions.

The functions include predicting 612 new nodes; a binary classifier may be used. The functions include predicting 614 new edges and predicting 616 disappearing nodes and edges. The nodes and edges establish the topology of the egocentric network, and additional information (e.g., contextual data, entity data, and relationship data) may be predicted.

The functions include predicting 618 node information and predicting 620 edge information. Node information may include, for example, various scores, sales numbers, entity data, revenue information, stock data, and the like. Edge information may include, for example, the type of relationship, the pecuniary investment in the relationship, the length of the relationship, other quantifiable benefits and detriments of the relationship, and the like.

The functions include looping 622 the process. The loop may initiate a return to the collecting 610 function automatically or if an accuracy threshold is not achieved such that the looping 622 may recur for a set number of iterations, time, or until an accuracy threshold is achieved. In some embodiments, the looping 622 function may not be used.

The functions include predicting 630 an entity robustness and updating 640 the egocentric network. The updated egocentric network 642 may be submitted to a database 602. The egocentric network 642 may be retained in the database 602 and updated as new data becomes available. The models used in developing the egocentric network 642 (e.g., predicting 612 new nodes and collecting 610 information) may be retrained for tuning and/or to account for new data.

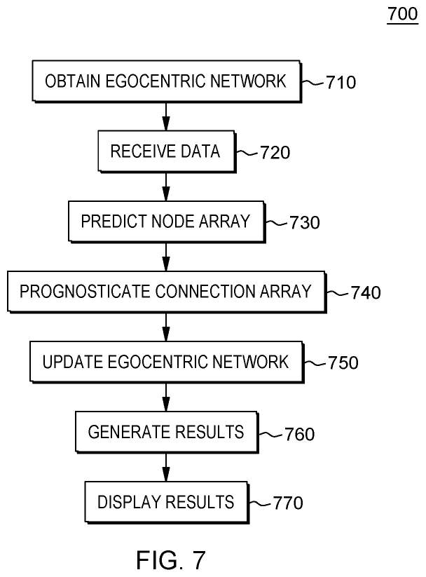

FIG. 7 depicts a method 700 in accordance with some embodiments of the present disclosure. The method 700 includes obtaining 710 an egocentric network such as by retrieving it from a database or building it with crawled data. The method 700 includes receiving 720 data such as by collecting it with a data crawler or pulling it from one or more databases.

The method 700 includes predicting 730 a node array. The node array may include current nodes in an egocentric network which are expected to remain as well as new nodes expected to join the network. Predicting 730 the node array may include identifying which nodes currently in the network will no longer be in the network and disappearing such nodes from the array. Thresholds for likeliness of nodes remaining, disappearing from, and joining the network may be predetermined by a user or according to any mechanism known in the art or hereinafter used. Thresholds may vary by user, goals, application, and the like. Various thresholds may be used, and differing thresholds may be used for different types of node calculations; for example, 51% confidence of a node remaining and 85% confidence of a node joining the network.

The method 700 may include prognosticating 740 the connection array. The connection array includes current links in an egocentric network which are expected to remain in, new links expected to join, and links expected to disappear from the network. Thresholds for identifying which links are likely to remain, join, and disappear may vary by user, goals, application, types of links, types of nodes, and the like.

The method 700 may include updating 750 the egocentric network, generating 760 results, and displaying 770 the results to a user. The results may include, for example, the updated egocentric network, a current egocentric network assessment, a predicted future egocentric network, a current entity robustness score, a predicted future entity robustness score, likely robustness scores for competing decisions, a financial health indicator, a recommendation concerning how to improve robustness, a revenue prediction, a likely change in supply chain (direct or indirect), a likely impact of a supply chain change, a likely impact of an internal business decision on a customer (direct or indirect), a probability of a change to an entity in the egocentric network, or some combination thereof.

A computer-implemented method in accordance with the present disclosure may include obtaining 710 an egocentric network for an entity; the egocentric network may have a center node. The method may include receiving 720 data about the entity. The method may include predicting 730, with the data, a node array of the egocentric network; the node array may include a first node to remain in the egocentric network, a second node to disappear from the egocentric network, and a third node to join the egocentric network. The method may include prognosticating 740, with the data; the connection array may include a first link connecting the first node to the center node, a second link disappearing from the egocentric network, and a third link connecting the third node to the center node. The method may include updating 750 the egocentric network to reflect the node array and the connection array, generating 760 an output based on the egocentric network, and displaying 770 the output to a user.

In some embodiments, the method may include compiling information from at least one source and building the egocentric network based on the information. In some embodiments, the method may further include retrieving a portion of the information from an external source.

In some embodiments, the method may include initiating a loop of the receiving, the predicting, and the prognosticating. In some embodiments, the method may further include achieving a threshold and exiting the loop.

In some embodiments, the output may include at least one of an updated egocentric network, an entity output prediction, and a new node recommendation.

In some embodiments, the method may include forecasting a fourth node of the node array connected to the center node via the first node, wherein the fourth node connects to the first node via a fourth link.

In some embodiments, the method may include projecting a future egocentric network using the data.

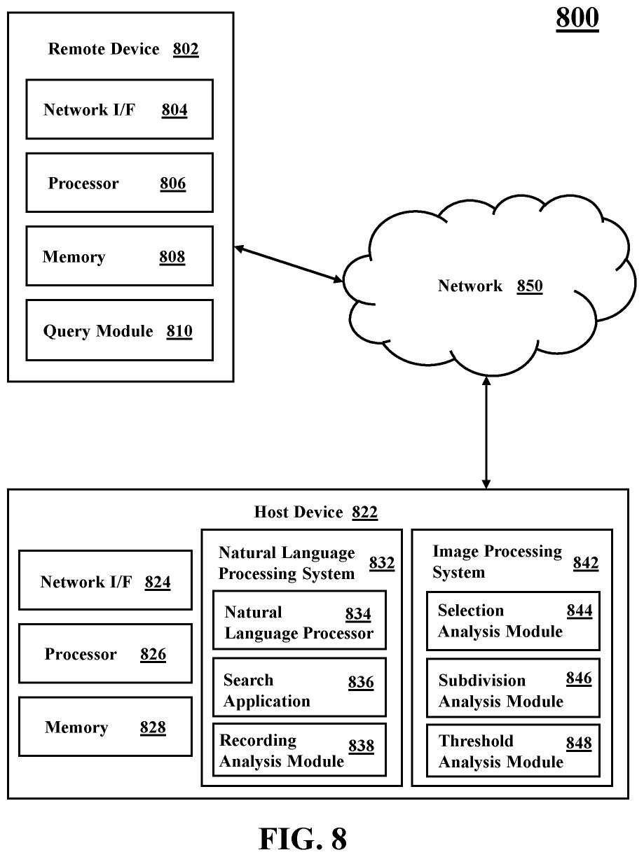

Some embodiments of the present disclosure may utilize a natural language parsing and/or subparsing component. Thus, aspects of the disclosure may relate to natural language processing. Accordingly, an understanding of the embodiments of the present invention may be aided by describing embodiments of natural language processing systems and the environments in which these systems may operate. Turning now to FIG. 8, illustrated is a block diagram of an example computing environment 800 in which illustrative embodiments of the present disclosure may be implemented. In some embodiments, the computing environment 800 may include a remote device 802 and a host device 822.

Consistent with various embodiments of the present disclosure, the host device 822 and the remote device 802 may be computer systems. The remote device 802 and the host device 822 may include one or more processors 806 and 826 and one or more memories 808 and 828, respectively. The remote device 802 and the host device 822 may be configured to communicate with each other through an internal or external network interface 804 and 824. The network interfaces 804 and 824 may be modems or network interface cards. The remote device 802 and/or the host device 822 may be equipped with a display such as a monitor. Additionally, the remote device 802 and/or the host device 822 may include optional input devices (e.g., a keyboard, mouse, scanner, or other input device) and/or any commercially available or custom software (e.g., browser software, communications software, server software, natural language processing software, search engine and/or web crawling software, filter modules for filtering content based upon predefined parameters, etc.). In some embodiments, the remote device 802 and/or the host device 822 may be servers, desktops, laptops, or hand-held devices.

The remote device 802 and the host device 822 may be distant from each other and communicate over a network 850. In some embodiments, the host device 822 may be a central hub from which remote device 802 can establish a communication connection, such as in a client-server networking model. Alternatively, the host device 822 and remote device 802 may be configured in any other suitable networking relationship (e.g., in a peer-to-peer configuration or using any other network topology).

In some embodiments, the network 850 can be implemented using any number of any suitable communications media. For example, the network 850 may be a wide area network (WAN), a local area network (LAN), an internet, or an intranet. In certain embodiments, the remote device 802 and the host device 822 may be local to each other and communicate via any appropriate local communication medium. For example, the remote device 802 and the host device 822 may communicate using a local area network (LAN), one or more hardwire connections, a wireless link or router, or an intranet. In some embodiments, the remote device 802 and the host device 822 may be communicatively coupled using a combination of one or more networks and/or one or more local connections. For example, the remote device 802 may be hardwired to the host device 822 (e.g., connected with an Ethernet cable) or the remote device 802 may communicate with the host device using the network 850 (e.g., over the Internet).

In some embodiments, the network 850 can be implemented within a cloud computing environment or using one or more cloud computing services. Consistent with various embodiments, a cloud computing environment may include a network-based, distributed data processing system that provides one or more cloud computing services. Further, a cloud computing environment may include many computers (e.g., hundreds or thousands of computers or more) disposed within one or more data centers and configured to share resources over the network 850.

In some embodiments, the remote device 802 may enable a user to input (or may input automatically with or without a user) a query (e.g., is any part of a recording artificial, etc.) to the host device 822 in order to identify subdivisions of a recording that include a particular subject. For example, the remote device 802 may include a query module 810 and a user interface (UI). The query module 810 may be in the form of a web browser or any other suitable software module, and the UI may be any type of interface (e.g., command line prompts, menu screens, graphical user interfaces). The UI may allow a user to interact with the remote device 802 to input, using the query module 810, a query to the host device 822, which may receive the query.

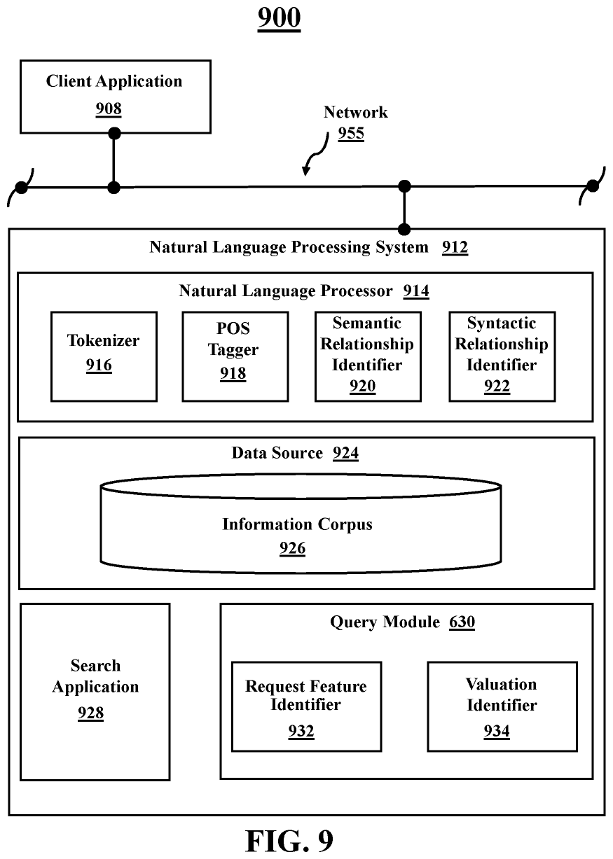

In some embodiments, the host device 822 may include a natural language processing system 832. The natural language processing system 832 may include a natural language processor 834, a search application 836, and a recording module 838. The natural language processor 834 may include numerous subcomponents, such as a tokenizer, a part-of-speech (POS) tagger, a semantic relationship identifier, and a syntactic relationship identifier. An example natural language processor is discussed in more detail in reference to FIG. 9.

The search application 836 may be implemented using a conventional or other search engine and may be distributed across multiple computer systems. The search application 836 may be configured to search one or more databases (e.g., repositories) or other computer systems for content that is related to a query submitted by the remote device 802. For example, the search application 836 may be configured to search dictionaries, papers, and/or archived reports to help identify a particular subject related to a query provided for a class. The recording analysis module 838 may be configured to analyze a recording to identify a particular subject (e.g., of the query). The recording analysis module 838 may include one or more modules or units, and may utilize the search application 836, to perform its functions (e.g., to identify a particular subject in a recording), as discussed in more detail in reference to FIG. 9.

In some embodiments, the host device 822 may include an image processing system 842. The image processing system 842 may be configured to analyze images associated with a recording to create an image analysis. The image processing system 842 may utilize one or more models, modules, or units to perform its functions (e.g., to analyze the images associated with the recording and generate an image analysis). For example, the image processing system 842 may include one or more image processing models that are configured to identify specific images related to a recording. The image processing models may include a section analysis module 844 to analyze single images associated with the recording and to identify the location of one or more features of the single images. As another example, the image processing system 842 may include a subdivision module 846 to group multiple images together identified to have a common feature of the one or more features. In some embodiments, image processing modules may be implemented as software modules. For example, the image processing system 842 may include a section analysis module and a subdivision analysis module. In some embodiments, a single software module may be configured to analyze the image(s) using image processing models.

In some embodiments, the image processing system 842 may include a threshold analysis module 848. The threshold analysis module 848 may be configured to compare the instances of a particular subject identified in a subdivision of sections of the recording against a threshold number of instances. The threshold analysis module 848 may then determine if the subdivision should be displayed to a user.

In some embodiments, the host device may have an optical character recognition (OCR) module. The OCR module may be configured to receive a recording sent from the remote device 802 and perform optical character recognition (or a related process) on the recording to convert it into machine-encoded text so that the natural language processing system 832 may perform NLP on the report. For example, a remote device 802 may transmit a video of a medical procedure to the host device 822. The OCR module may convert the video into machine-encoded text and then the converted video may be sent to the natural language processing system 832 for analysis. In some embodiments, the OCR module may be a subcomponent of the natural language processing system 832. In other embodiments, the OCR module may be a standalone module within the host device 822. In still other embodiments, the OCR module may be located on the remote device 802 and may perform OCR on the recording before the recording is sent to the host device 822.

While FIG. 8 illustrates a computing environment 800 with a single host device 822 and a remote device 802, suitable computing environments for implementing embodiments of this disclosure may include any number of remote devices and host devices. The various models, modules, systems, and components illustrated in FIG. 8 may exist, if at all, across a plurality of host devices and remote devices. For example, some embodiments may include two host devices. The two host devices may be communicatively coupled using any suitable communications connection (e.g., using a WAN, a LAN, a wired connection, an intranet, or the Internet). The first host device may include a natural language processing system configured to receive and analyze a video, and the second host device may include an image processing system configured to receive and analyze .GIFS to generate an image analysis.

It is noted that FIG. 8 is intended to depict the representative major components of an exemplary computing environment 800. In some embodiments, however, individual components may have greater or lesser complexity than as represented in FIG. 8, components other than or in addition to those shown in FIG. 8 may be present, and the number, type, and configuration of such components may vary.

Referring now to FIG. 9, shown is a block diagram of an exemplary system architecture 900 including a natural language processing system 912 configured to analyze data to identify objects of interest (e.g., possible anomalies, natural data, etc.), in accordance with embodiments of the present disclosure. In some embodiments, a remote device (such as remote device 802 of FIG. 8) may submit a text segment and/or a corpus to be analyzed to the natural language processing system 812 which may be housed on a host device (such as host device 822 of FIG. 8). Such a remote device may include a client application 908, which may itself involve one or more entities operable to generate or modify information associated with the recording and/or query that is then dispatched to a natural language processing system 912 via a network 955.

Consistent with various embodiments of the present disclosure, the natural language processing system 912 may respond to text segment and corpus submissions sent by a client application 908. Specifically, the natural language processing system 912 may analyze a received text segment and/or corpus (e.g., video, news article, etc.) to identify an object of interest. In some embodiments, the natural language processing system 912 may include a natural language processor 914, data sources 924, a search application 928, and a query module 930. The natural language processor 914 may be a computer module that analyzes the recording and the query. The natural language processor 914 may perform various methods and techniques for analyzing recordings and/or queries (e.g., syntactic analysis, semantic analysis, etc.). The natural language processor 914 may be configured to recognize and analyze any number of natural languages. In some embodiments, the natural language processor 914 may group one or more sections of a text into one or more subdivisions. Further, the natural language processor 914 may include various modules to perform analyses of text or other forms of data (e.g., recordings, etc.). These modules may include, but are not limited to, a tokenizer 916, a part-of-speech (POS) tagger 918 (e.g., which may tag each of the one or more sections of text in which the particular object of interest is identified), a semantic relationship identifier 920, and a syntactic relationship identifier 922.

In some embodiments, the tokenizer 916 may be a computer module that performs lexical analysis. The tokenizer 916 may convert a sequence of characters (e.g., images, sounds, etc.) into a sequence of tokens. A token may be a string of characters included in a recording and categorized as a meaningful symbol. Further, in some embodiments, the tokenizer 916 may identify word boundaries in a body of text and break any text within the body of text into their component text elements, such as words, multiword tokens, numbers, and punctuation marks. In some embodiments, the tokenizer 916 may receive a string of characters, identify the lexemes in the string, and categorize them into tokens.

Consistent with various embodiments, the POS tagger 918 may be a computer module that marks up a word in a recording to correspond to a particular part of speech. The POS tagger 918 may read a passage or other text in natural language and assign a part of speech to each word or other token. The POS tagger 918 may determine the part of speech to which a word (or other spoken element) corresponds based on the definition of the word and the context of the word. The context of a word may be based on its relationship with adjacent and related words in a phrase, sentence, or paragraph. In some embodiments, the context of a word may be dependent on one or more previously analyzed body of texts and/or corpora (e.g., the content of one text segment may shed light on the meaning of one or more objects of interest in another text segment). Examples of parts of speech that may be assigned to words include, but are not limited to, nouns, verbs, adjectives, adverbs, and the like. Examples of other part of speech categories that POS tagger 918 may assign include, but are not limited to, comparative or superlative adverbs, wh-adverbs, conjunctions, determiners, negative particles, possessive markers, prepositions, wh-pronouns, and the like. In some embodiments, the POS tagger 918 may tag or otherwise annotate tokens of a recording with part of speech categories. In some embodiments, the POS tagger 918 may tag tokens or words of a recording to be parsed by the natural language processing system 912.

In some embodiments, the semantic relationship identifier 920 may be a computer module that may be configured to identify semantic relationships of recognized subjects (e.g., words, phrases, images, etc.) in a body of text/corpus. In some embodiments, the semantic relationship identifier 920 may determine functional dependencies between entities and other semantic relationships.

Consistent with various embodiments, the syntactic relationship identifier 922 may be a computer module that may be configured to identify syntactic relationships in a body of text/corpus composed of tokens. The syntactic relationship identifier 922 may determine the grammatical structure of sentences such as, for example, which groups of words are associated as phrases and which word is the subject or object of a verb. The syntactic relationship identifier 922 may conform to formal grammar.

In some embodiments, the natural language processor 914 may be a computer module that may group sections of a recording into subdivisions and generate corresponding data structures for one or more subdivisions of the recording. For example, in response to receiving a text segment at the natural language processing system 912, the natural language processor 914 may output subdivisions of the text segment as data structures. In some embodiments, a subdivision may be represented in the form of a graph structure. To generate the subdivision, the natural language processor 914 may trigger computer modules 916-922.

In some embodiments, the output of natural language processor 914 may be used by search application 928 to perform a search of a set of (i.e., one or more) corpora to retrieve one or more subdivisions including a particular subject associated with a query (e.g., in regard to an object of interest) and send the output to an image processing system and to a comparator. As used herein, a corpus may refer to one or more data sources, such as a data source 924 of FIG. 9. In some embodiments, data sources 924 may include video libraries, data warehouses, information corpora, data models, and/or document repositories. In some embodiments, the data sources 924 may include an information corpus 926. The information corpus 926 may enable data storage and retrieval. In some embodiments, the information corpus 926 may be a subject repository that houses a standardized, consistent, clean, and integrated list of images and text. For example, an information corpus 926 may include teaching presentations that include step by step images and comments on how to perform a function. Data may be sourced from various operational systems. Data stored in an information corpus 926 may be structured in a way to specifically address reporting and analytic requirements. In some embodiments, an information corpus 926 may be a relational database.

In some embodiments, a query module 930 may be a computer module that identifies objects of interest within sections of a text, or other forms of data. In some embodiments, a query module 930 may include a request feature identifier 932 and a valuation identifier 934. When a query is received by the natural language processing system 912, the query module 930 may be configured to analyze text using natural language processing to identify an object of interest. The query module 930 may first identity one or more objects of interest in the text using the natural language processor 914 and related subcomponents 916-922. After identifying the one or more objects of interest, the request feature identifier 932 may identify one or more common objects of interest (e.g., anomalies, artificial content, natural data, etc.) present in sections of the text (e.g., the one or more text segments of the text). In some embodiments, the common objects of interest in the sections may be the same object of interest that is identified. Once a common object of interest is identified, the request feature identifier 932 may be configured to transmit the text segments that include the common object of interest to an image processing system (shown in FIG. 8) and/or to a comparator.

After identifying common objects of interest using the request feature identifier 932, the query module may group sections of text having common objects of interest. The valuation identifier 934 may then provide a value to each text segment indicating how close the object of interest in each text segment is related to one another (and thus indicates artificial and/or real data). In some embodiments, the particular subject may have one or more of the common objects of interest identified in the one or more sections of text. After identifying a particular object of interest relating to the query (e.g., identifying that one or more of the common objects of interest may be an anomaly), the valuation identifier 934 may be configured to transmit the criterion to an image processing system (shown in FIG. 8) and/or to a comparator (which may then determine the validity of the common and/or particular objects of interest).

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment currently known or that which may be later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model with different physical and virtual resources dynamically assigned and reassigned according to demand. There is a sense of portion independence in that the consumer generally has no control or knowledge over the exact portion of the provided resources but may be able to specify portion at a higher level of abstraction (e.g., country, state, or datacenter).

Rapid elasticity: capabilities can be rapidly and elastically provisioned, in some cases automatically, to quickly scale out and rapidly release to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but the consumer has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software which may include operating systems and applications. The consumer does not manage or control the underlying cloud infrastructure but has control over operating systems, storage, and deployed applications, and the consumer possibly has limited control of select networking components (e.g., host firewalls).

Deployment models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and/or compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

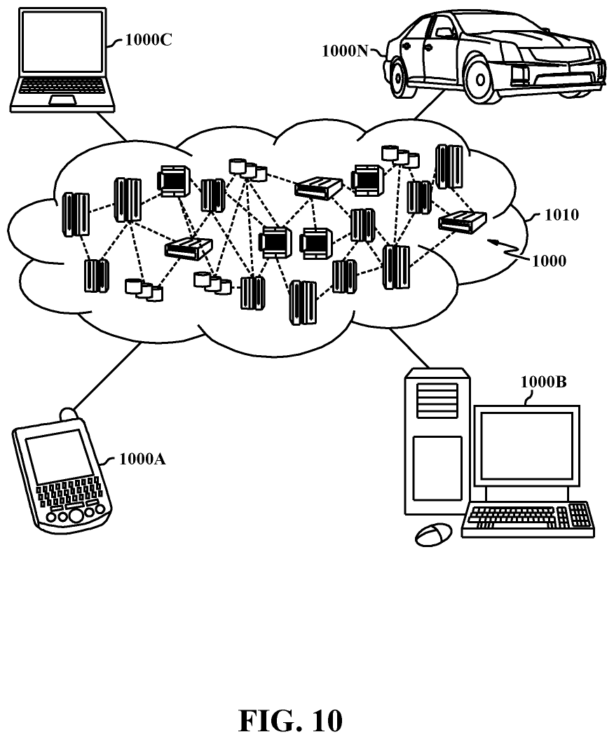

FIG. 10 illustrates a cloud computing environment 1010 in accordance with embodiments of the present disclosure. As shown, cloud computing environment 1010 includes one or more cloud computing nodes 1000 with which local computing devices used by cloud consumers such as, for example, personal digital assistant (PDA) or cellular telephone 1000A, desktop computer 1000B, laptop computer 1000C, and/or automobile computer system 1000N may communicate. Nodes 1000 may communicate with one another. They may be grouped (not shown) physically or virtually, in one or more networks, such as private, community, public, or hybrid clouds as described hereinabove, or a combination thereof.

This allows cloud computing environment 1010 to offer infrastructure, platforms, and/or software as services for which a cloud consumer does not need to maintain resources on a local computing device. It is understood that the types of computing devices 1000A-N shown in FIG. 10 are intended to be illustrative only and that computing nodes 1000 and cloud computing environment 1010 can communicate with any type of computerized device over any type of network and/or network addressable connection (e.g., using a web browser).

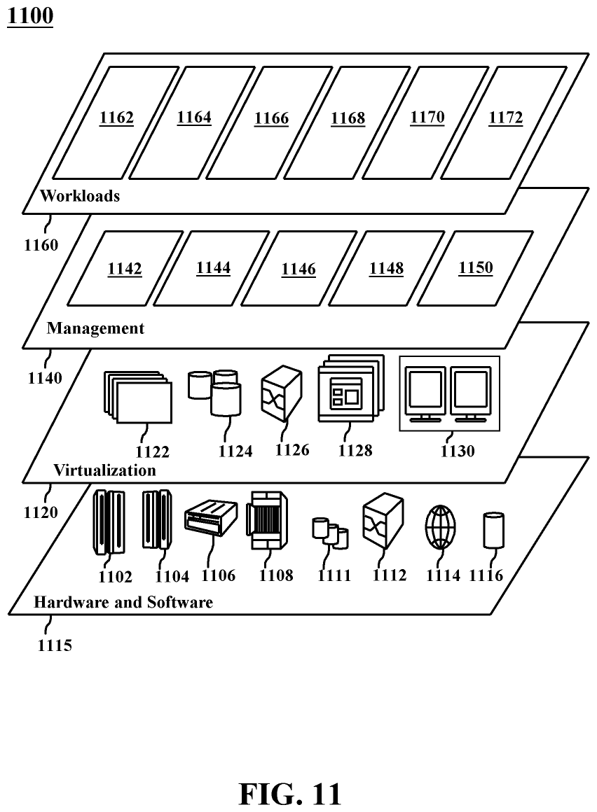

FIG. 11 illustrates abstraction model layers 1100 provided by cloud computing environment 1010 (FIG. 10) in accordance with embodiments of the present disclosure. It should be understood in advance that the components, layers, and functions shown in FIG. 11 are intended to be illustrative only and embodiments of the disclosure are not limited thereto. As depicted below, the following layers and corresponding functions are provided.

Hardware and software layer 1115 includes hardware and software components. Examples of hardware components include: mainframes 1102; RISC (Reduced Instruction Set Computer) architecture-based servers 1104; servers 1106; blade servers 1108; storage devices 1111; and networks and networking components 1112. In some embodiments, software components include network application server software 1114 and database software 1116.

Virtualization layer 1120 provides an abstraction layer from which the following examples of virtual entities may be provided: virtual servers 1122; virtual storage 1124; virtual networks 1126, including virtual private networks; virtual applications and operating systems 1128; and virtual clients 1130.

In one example, management layer 1140 may provide the functions described below. Resource provisioning 1142 provides dynamic procurement of computing resources and other resources that are utilized to perform tasks within the cloud computing environment. Metering and pricing 1144 provide cost tracking as resources and are utilized within the cloud computing environment as well as billing or invoicing for consumption of these resources. In one example, these resources may include application software licenses. Security provides identity verification for cloud consumers and tasks as well as protection for data and other resources. User portal 1146 provides access to the cloud computing environment for consumers and system administrators. Service level management 1148 provides cloud computing resource allocation and management such that required service levels are met. Service level agreement (SLA) planning and fulfillment 1150 provide pre-arrangement for, and procurement of, cloud computing resources for which a future requirement is anticipated in accordance with an SLA.

Workloads layer 1160 provides examples of functionality for which the cloud computing environment may be utilized. Examples of workloads and functions which may be provided from this layer include: mapping and navigation 1162; software development and lifecycle management 1164; virtual classroom education delivery 1166; data analytics processing 1168; transaction processing 1170; and predicting entity robustness 1172.

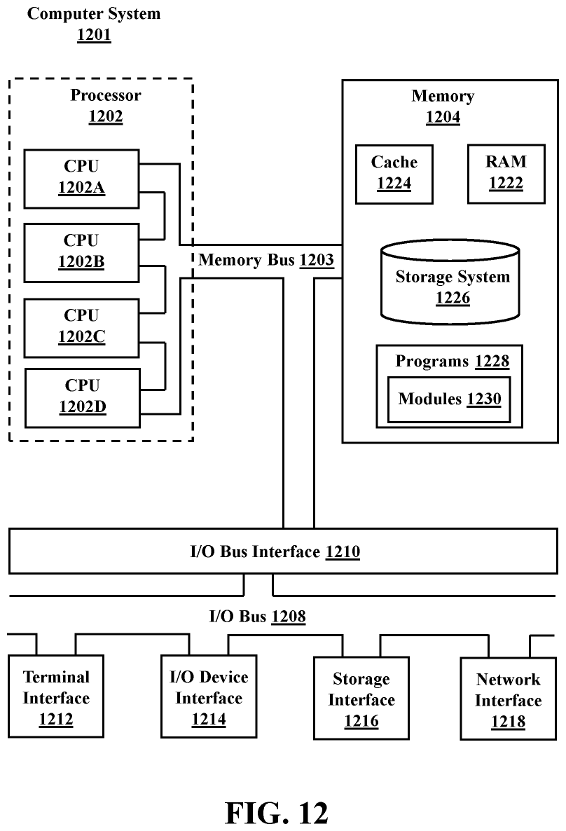

FIG. 12 illustrates a high-level block diagram of an example computer system 1201 that may be used in implementing one or more of the methods, tools, and modules, and any related functions, described herein (e.g., using one or more processor circuits or computer processors of the computer) in accordance with embodiments of the present disclosure. In some embodiments, the major components of the computer system 1201 may comprise a processor 1202 with one or more central processing units (CPUs) 1202A, 1202B, 1202C, and 1202D, a memory subsystem 1204, a terminal interface 1212, a storage interface 1216, an I/O (Input/Output) device interface 1214, and a network interface 1218, all of which may be communicatively coupled, directly or indirectly, for inter-component communication via a memory bus 1203, an I/O bus 1208, and an I/O bus interface unit 1210.

The computer system 1201 may contain one or more general-purpose programmable CPUs 1202A, 1202B, 1202C, and 1202D, herein generically referred to as the CPU 1202. In some embodiments, the computer system 1201 may contain multiple processors typical of a relatively large system; however, in other embodiments, the computer system 1201 may alternatively be a single CPU system. Each CPU 1202 may execute instructions stored in the memory subsystem 1204 and may include one or more levels of on-board cache.

System memory 1204 may include computer system readable media in the form of volatile memory, such as random access memory (RAM) 1222 or cache memory 1224. Computer system 1201 may further include other removable/non-removable, volatile/non-volatile computer system storage media. By way of example only, storage system 1226 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM, or other optical media can be provided. In addition, memory 1204 can include flash memory, e.g., a flash memory stick drive or a flash drive. Memory devices can be connected to memory bus 1203 by one or more data media interfaces. The memory 1204 may include at least one program product having a set (e.g., at least one) of program modules that are configured to carry out the functions of various embodiments.

One or more programs/utilities 1228, each having at least one set of program modules 1230, may be stored in memory 1204. The programs/utilities 1228 may include a hypervisor (also referred to as a virtual machine monitor), one or more operating systems, one or more application programs, other program modules, and program data. Each of the operating systems, one or more application programs, other program modules, and program data, or some combination thereof, may include an implementation of a networking environment. Programs 1228 and/or program modules 1230 generally perform the functions or methodologies of various embodiments.

Although the memory bus 1203 is shown in FIG. 12 as a single bus structure providing a direct communication path among the CPUs 1202, the memory subsystem 1204, and the I/O bus interface 1210, the memory bus 1203 may, in some embodiments, include multiple different buses or communication paths, which may be arranged in any of various forms, such as point-to-point links in hierarchical, star, or web configurations, multiple hierarchical buses, parallel and redundant paths, or any other appropriate type of configuration. Furthermore, while the I/O bus interface 1210 and the I/O bus 1208 are shown as single respective units, the computer system 1201 may, in some embodiments, contain multiple I/O bus interface units 1210, multiple I/O buses 1208, or both. Further, while multiple I/O interface units 1210 are shown, which separate the I/O bus 1208 from various communications paths running to the various I/O devices, in other embodiments some or all of the I/O devices may be connected directly to one or more system I/O buses 1208.

In some embodiments, the computer system 1201 may be a multi-user mainframe computer system, a single-user system, a server computer, or similar device that has little or no direct user interface but receives requests from other computer systems (clients). Further, in some embodiments, the computer system 1201 may be implemented as a desktop computer, portable computer, laptop or notebook computer, tablet computer, pocket computer, telephone, smartphone, network switches or routers, or any other appropriate type of electronic device.

It is noted that FIG. 12 is intended to depict the representative major components of an exemplary computer system 1201. In some embodiments, however, individual components may have greater or lesser complexity than as represented in FIG. 12, components other than or in addition to those shown in FIG. 12 may be present, and the number, type, and configuration of such components may vary.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide, or other transmission media (e.g., light pulses passing through a fiber-optic cable) or electrical signals transmitted through a wire.

Computer readable program instructions described herein can be downloaded to respective computing/processing devices from a computer readable storage medium or to an external computer or external storage device via a network, for example, the Internet, a local area network, a wide area network, and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a standalone software package, partly on the user's computer and partly on a remote computer, or entirely on a remote computer or server. In the latter scenario, the remote computer may be connected to the user's computer through any type of network, including a local area network (LAN) or a wide area network (WAN) or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although the present disclosure has been described in terms of specific embodiments, it is anticipated that alterations and modifications thereof will become apparent to the skilled in the art. The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application, or the technical improvement over technologies found in the marketplace or to enable others of ordinary skill in the art to understand the embodiments disclosed herein. Therefore, it is intended that the following claims be interpreted as covering all such alterations and modifications as fall within the true spirit and scope of the disclosure.

What is claimed is:

1. A system, said system comprising:
a memory; and
a processor in communication with said memory, said processor being configured to perform operations, said operations comprising:
obtaining an egocentric network for an entity, wherein said egocentric network has a center node;
receiving data about said entity;
predicting, with said data, a node array of said egocentric network including a first node to remain, a second node to disappear, and a third node to join said egocentric network;
prognosticating, with said data, a connection array of said egocentric network including a first link connecting said first node to said center node, a second link disappearing from said egocentric network, and a third link connecting said third node to said center node;
updating said egocentric network to reflect said node array and said connection array;
generating an output based on said egocentric network; and
displaying said output to a user.

2. The system of claim 1, further comprising:
compiling information from at least one source; and
building said egocentric network based on said information.

3. The system of claim 1, further comprising:
initiating a loop of said receiving, said predicting, and said prognosticating.

4. The system of claim 1, wherein:
said output includes at least one of the group comprising an updated egocentric network, an entity output prediction, and a new node recommendation.

5. The system of claim 1, further comprising:
forecasting a fourth node of said node array connected to said center node via said first node, wherein said fourth node connects to said first node via a fourth link.

6. The system of claim 1, further comprising:
projecting a future egocentric network using said data.

7. A computer-implemented method, said method comprising:
obtaining an egocentric network for an entity, wherein said egocentric network has a center node;
receiving data about said entity;
predicting, with said data, a node array of said egocentric network including a first node to remain, a second node to disappear, and a third node to join said egocentric network;
prognosticating, with said data, a connection array of said egocentric network including a first link connecting said first node to said center node, a second link disappearing from said egocentric network, and a third link connecting said third node to said center node;
updating said egocentric network to reflect said node array and said connection array;
generating an output based on said egocentric network; and
displaying said output to a user.

8. The computer-implemented method of claim 7, further comprising:
compiling information from at least one source; and
building said egocentric network based on said information.

9. The computer-implemented method of claim 8, further comprising:
retrieving a portion of said information from an external source.

10. The computer-implemented method of claim 7, further comprising:
initiating a loop of said receiving, said predicting, and said prognosticating.

11. The computer-implemented method of claim 10, further comprising:
achieving a threshold; and
exiting said loop.

12. The computer-implemented method of claim 7, wherein:
said output includes at least one of the group comprising an updated egocentric network, an entity output prediction, and a new node recommendation.

13. The computer-implemented method of claim 7, further comprising:
forecasting a fourth node of said node array connected to said center node via said first node, wherein said fourth node connects to said first node via a fourth link.

14. The computer-implemented method of claim 7, further comprising:
projecting a future egocentric network using said data.

15. A computer program product, said computer program product comprising a computer readable storage medium having program instructions embodied therewith, said program instructions executable by a processor to cause said processor to perform a function, said function comprising:
obtaining an egocentric network for an entity, wherein said egocentric network has a center node;
receiving data about said entity;
predicting, with said data, a node array of said egocentric network including a first node to remain, a second node to disappear, and a third node to join said egocentric network;
prognosticating, with said data, a connection array of said egocentric network including a first link connecting said first node to said center node, a second link disappearing from said egocentric network, and a third link connecting said third node to said center node;
updating said egocentric network to reflect said node array and said connection array;
generating an output based on said egocentric network; and
displaying said output to a user.

16. The computer program product of claim 15, further comprising:
compiling information from at least one source; and
building said egocentric network based on said information.

17. The computer program product of claim 15, further comprising:
initiating a loop of said receiving, said predicting, and said prognosticating.

18. The computer program product of claim 15, wherein:
said output includes at least one of the group comprising an updated egocentric network, an entity output prediction, and a new node recommendation.

19. The computer program product of claim 15, further comprising:
forecasting a fourth node of said node array connected to said center node via said first node, wherein said fourth node connects to said first node via a fourth link.

20. The computer program product of claim 15, further comprising:
projecting a future egocentric network using said data.
